(19) United States
(12) Patent Application Publication
(10) Pub. No.: US 2015/0117866 A1
(43) Pub. Date: Apr. 30, 2015

(54) QUADRATURE AMPLITUDE MODULATION SYMBOL MAPPING

(71) Applicant: ZTE Corporation, Shenzhen (CN)

(72) Inventors: Hung-Chang Chien, Bridgewater, NJ (US); Zhensheng Jia, Morganville, NJ (US); Jianjun Yu, Basking Ridge, NJ (US)

(21) Appl. No.: 14/527,371

(22) Filed: Oct. 29, 2014

Related U.S. Application Data
(60) Provisional application No. 61/898,251, filed on Oct. 31, 2013.

(51) Int. Cl. H04L 27/34; H04B 10/61; H04B 10/516; H04L 27/38; H04L 27/36

(52) U.S. Cl. CPC H04L 27/3483; H04L 27/38; H04L 27/389; H04L 27/361; H04B 10/5161; H04B 10/612
USPC 398/140; 375/320; 375/298

(57) ABSTRACT

Modulation and demodulation of digital signals comprising symbols representing four or more bits uses a constellation map in which initial two bits of the modulated data identify a quadrant of the constellation map and the remaining bits of the modulated data identify a symbol within the quadrant corresponding to the four or more data bits. In some systems, the constellation map is made up from each successive two bits of the input data bits successively identifying a quadrant within a quadrant until a group of bits is uniquely mapped to a single symbol.

### CROSS REFERENCE TO RELATED APPLICATIONS

This patent application claims the benefit of U.S. Provisional Patent Application No. 61/898,251, filed on Oct. 31, 2013. The entire content of the before-mentioned patent application is incorporated by reference as part of the disclosure of this application.

### BACKGROUND

This patent document relates to digital communication, and, in one aspect, multi-carrier optical communication systems.

There is an ever-growing demand for data communication in application areas such as wireless communication, fiber optic communication and so on. The demand on core networks is especially higher because not only are user devices such as smartphones and computers using more and more bandwidth due to multimedia applications, but also the total number of devices for which data is carried over core networks is increasing. For profitability and to meet increasing demand, equipment manufacturers and network operators are continually looking for ways in which operational and capital expenditure can be reduced.

### SUMMARY

The present document discloses techniques for mapping data bits to Quadrature Amplitude Modulation (QAM) symbol constellations and de-mapping QAM symbols to data bits. A QAM constellation map provides correspondence between symbols and data bits represented by the symbols. Various examples of constellation maps are disclosed which lend themselves to robust transmission and reception performance. In some disclosed embodiments QAM constellations of order 4 our greater (e.g., 16-QAM, 32-QAM, 64-QAM, etc.) are mapped by first identifying a quadrant based on initial two bits and then identifying a symbol within the quadrant based on the remaining bits of the data bits.

In one aspect, a method of digital communication includes receiving a digital signal comprising modulated symbols in which four or more data bits are mapped to each symbol using a constellation map, generating a first decision for each received modulated symbol, the first decision associating a quadrant of the constellation map to the received modulated symbol and performing, based on the quadrant of the constellation map associated with the received modulated symbol, a second decision to recover data bits mapped into the received symbol.

In another aspect an apparatus for processing a symbol stream to generate data encoded by the symbol stream is disclosed. Each symbol represents a fixed number of data bits of a constellation map, and the fixed number is an integer greater than three. A constellation map represents a one-to-one correspondence all possible combinations of the fixed number of data bits and a corresponding symbol. The apparatus includes a first stage that receives a symbol from the symbol stream and decides, using quadrature phase shift keying (QPSK) demodulation processing, a corresponding quadrant of the constellation map the symbol maps to, and a second stage that receives the symbol and the decision from the first stage about which quadrant the symbol maps to and performs further demapping to recover data bits corresponding to the symbol.

These, and other aspects, are disclosed in the present document.

### BRIEF DESCRIPTION OF THE DRAWINGS

FIG. 1 shows a prior art constellation map of Gray encoded symbols.

FIG. 2 shows an exemplary 16 QAM constellation map.

FIG. 3 shows an exemplary optical communication system.

FIG. 4 shows an example of a relationship between various constellation mappings.

FIG. 5 shows another example of a relationship between various constellation mappings.

FIG. 6 lists an exemplary Table of constellation transformation between QPSK and 16-QAM signals.

FIG. 7 depicts exemplary spectra of modulated signals.

FIG. 8 shows a quadrant of an exemplary 64 QAM constellation map.

FIG. 9 shows an exemplary 64 QAM constellation map.

FIG. 10 is a flowchart representation of an exemplary method of digital communication.

FIG. 11 is a block diagram representation of an exemplary digital communication apparatus.

FIG. 12 is a flowchart representation of an exemplary method of transmitting digital signals.

### DETAILED DESCRIPTION

Presently deployed optical networking equipment typically uses quadrature phase shift keying (QPSK) modulation to meet the distance requirements for the given signal to noise ratio of the optical medium (glass). While QPSK offers robust modulation, to meet the increased demand for bandwidth may be useful to use higher modulation schemes. However, the use of increased modulation density often makes transmissions more susceptible to transmission errors. The techniques presented in the present document, in one aspect, advantageously allow higher constellation transmissions, while still retaining certain advantages of QPSK. For example, today, it is possible to transmit optical signals over 3,000 kilometers using QPSK modulation and achieve 100 Gbps throughput. By contrast, if the modulation density is increased to a higher order scheme (e.g., 16-QAM instead of 8-QAM or QPSK) to achieve higher data throughput (e.g., 400 Gbps) the higher throughput can be achieved only over a much shorter distance, e.g., 1000 kilometers due to degradation in Signal to Noise Ratio (SNR) over longer distances. Using the techniques disclosed in the present document, higher order modulation schemes, such as 16-QAM, may be used to increase data throughputs, while maintaining the same distance (e.g., 3,000 Kilometers) over which data can be transmitted below the same error threshold as in conventional systems.

In digital communication, the operation of digital modulation (or demodulation) can be described using a graphical representation often called a constellation map (or a constellation diagram). A constellation map refers to a two-dimensional scatter diagram in a complex plane, with in-phase and quadrature-phase axes, with locations of constellation symbols and the corresponding bit pattern that is mapped to that location. For example, when two binary information bits are together mapped to symbols, four symbols are possible, corresponding to the four possible combinations of information bits: 00, 01, 10 and 11.

Gray coding is a well-known technique in which the bits-to-symbol mapping is performed such that neighboring symbols (shortest distance) in a constellation map differ only in one bit position. For example, in the above-described example of two information bit symbols, symbols corresponding to “00” and “11” (and “01” and “10”) would not be mapped as neighboring symbols because both bits change in this combination, while “00” may be a neighbor of “10” and “01” because only one bit position changes value.

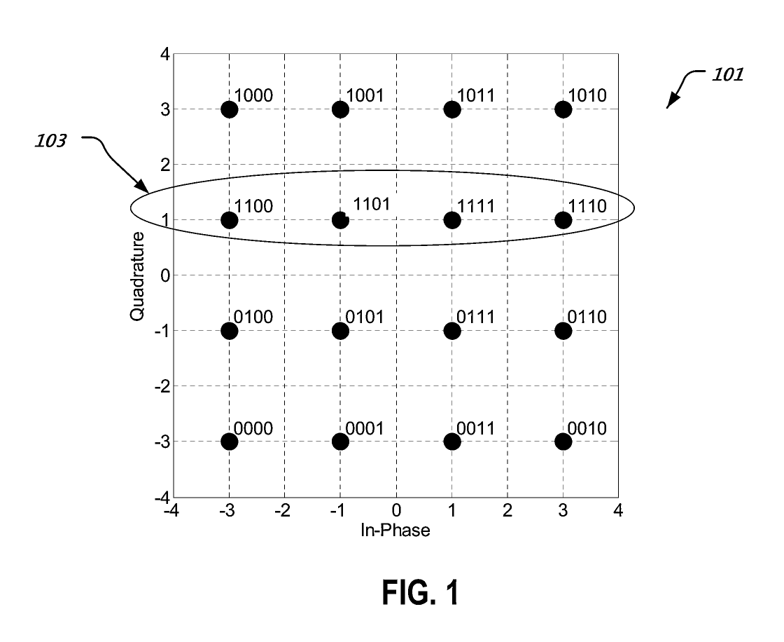

FIG. 1 is a constellation map 101 of an example Gray coding mapping of four information bits to possible 2⁴ or 16 symbols. It can be easily verified that for each symbol, all neighboring symbols (separated by two segments of the square grid, or unit distance away from each other along horizontal or vertical axis) differ only in 1 bit position.

Transmission of digital signals using Gray coding, and correspondingly reception by Gray code-mapping, can be done using various techniques such as symbol-to-constellation lookup tables, mapping logic, and so on. While Gray coding has certain useful properties for robust transmission and reception of signals (e.g., reducing number of bit errors based on errors in symbol decisions), the inventors realized that Gray encoded digital modulation schemes do not lend themselves to easy cascaded or step-wise implementation of transmit or receive operations. For example, four symbols (callout 103) that commonly share “11” as the first two bits, are still one, two and three units away from each other in the constellation map.

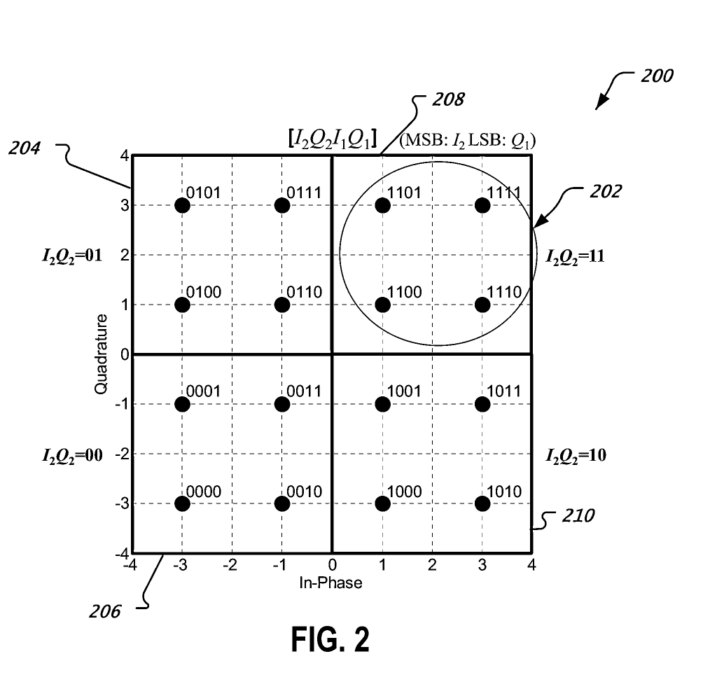

FIG. 2 depicts a constellation map 200 example in which the mapping between data bits and constellation symbols does not follow the above-discussed property of Gray encoding. For example, all four symbols that have the first two (leftmost two) bits “11” (reference number 202) are seen to be located within the quadrant 208, with other quadrants 204, 206 and 210 sharing a similar property that all four constellation points within the quadrant have the same two leftmost bits. In other words, given the two leftmost bits (which could be first in time or last in time bits, depending on implementations), there is a unique correspondence to the quadrant of the constellation map to which the symbol is mapped to.

It can be seen that the symbols in FIG. 2 are not Gray encoded, with neighboring symbols across quadrant boundaries differing in more than one bit positions (e.g., symbols 0100 and 1001 are adjacent to each other). However, as explained in the present document, a receiver that performs a cascaded stage-wise de-mapping, may overcome such multi-bit transitions and errors in decision process at least based on benefits from the superiority of the QPSK receiving techniques that may be used in an earlier stage or data recovery and de-mapping.

In the present document, techniques that generalize the above-described mapping to multi-bit symbol constellations (e.g., 6 bit symbols, 8-bit symbols, and so on) are disclosed. Further, advantageous use of the mapping between symbols and constellations to derive operational efficiencies in the implementation at the transmitter-side and the receiver-side of a digital communication system are disclosed. These, and other, advantages of the disclosed techniques will be apparent to one of skill in the art after reading the present disclosure.

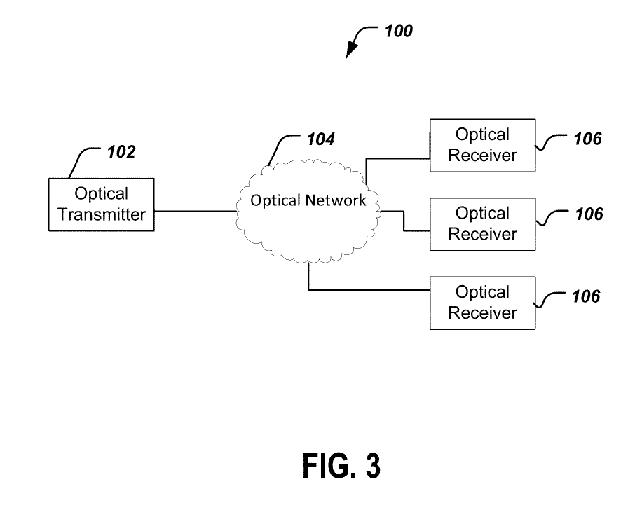

FIG. 3 depicts an optical communication system 100 in which the presently disclosed technology can be practiced. One or more optical transmitters 102 are communicatively coupled via an optical network 104 with one or more optical receivers 106. The optical network 104 may comprise optical fibers that extend in length from several hundred feet (e.g., last mile drop) to several thousands of kilometers (long haul networks). The transmitted optical signals may go through intermediate optical equipment such as amplifiers, repeaters, switch, etc., which are not shown in FIG. 3 for clarity.

As discussed with respect to FIG. 1, a 16-QAM signal can be generated by mapping from a binary sequence with Gray coding. Each symbol represents four bits [I₂Q₂I₁Q₁], where I₂ may be the most significant bit (MSB) and Q₁ may be the least significant bit (LSB), and the adjacent constellation points differ only one bit.

The 16-QAM constellation map depicted in FIG. 2 can be generated by inverse Fourier transformation of two Gray-code mapped QPSK sequences that have an amplitude ratio of 2:1. This operation divides a 16-QAM constellation into four Gray-coded subsets, one for each quadrant.

In some receiver embodiments, rather than having to de-map a full 16-QAM signal constellation at once, implementation complexity can be lowered by first de-mapping the received signal into one of four QPSK quadrants and then processing the signal to identify and de-map to a constellation point within the quadrant. In such a case, the complexity of a 16-QAM channel equalization and de-mapping implementation may be replaced by a more robust implementation having two QPSK de-mapping stages, with the first stage performing QPSK channel equalization.

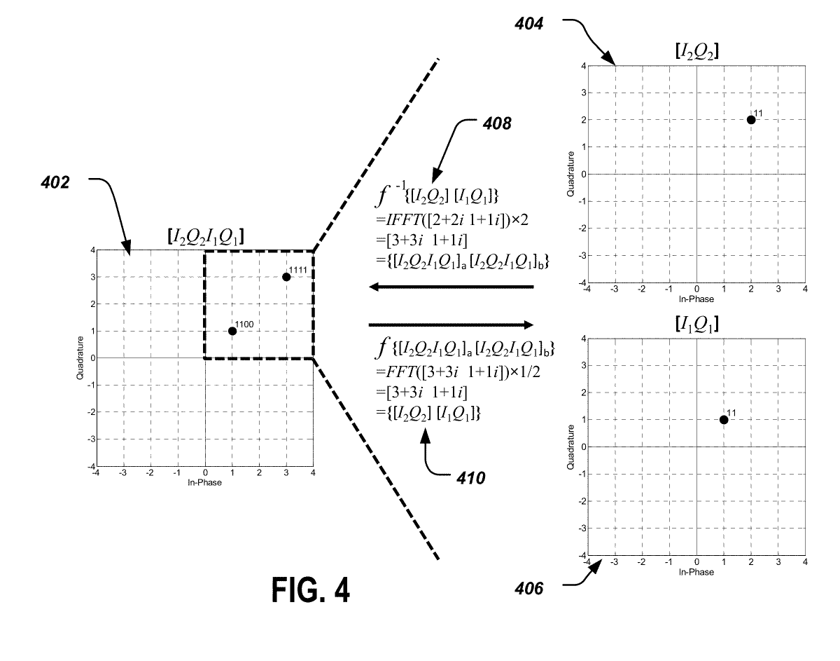

FIG. 4 shows an example of mapping and de-mapping mechanism from high-order 16QAM to two subsets of low-order QPSK on a 2-on-2 basis. In one configuration, two QPSK symbols with a relative amplitude ratio (a) of 2: [I₂Q₂]=11 and [I₁Q₁]=11, and the constellation points are (2+2i) and (1+1i), respectively may be used. Taking 2-point inverse fast Fourier transformation (IFFT) of these two complex value and scaling them by a factor of 2, results in the complex numbers (3+3i) and (1+1i), representing two 16QAM constellation points [I₂Q₂I₁Q₁]=1111 and 1100, respectively. The mapping process is fully invertible. It is noted that the scaling factor becomes ½ when FFT is taken.

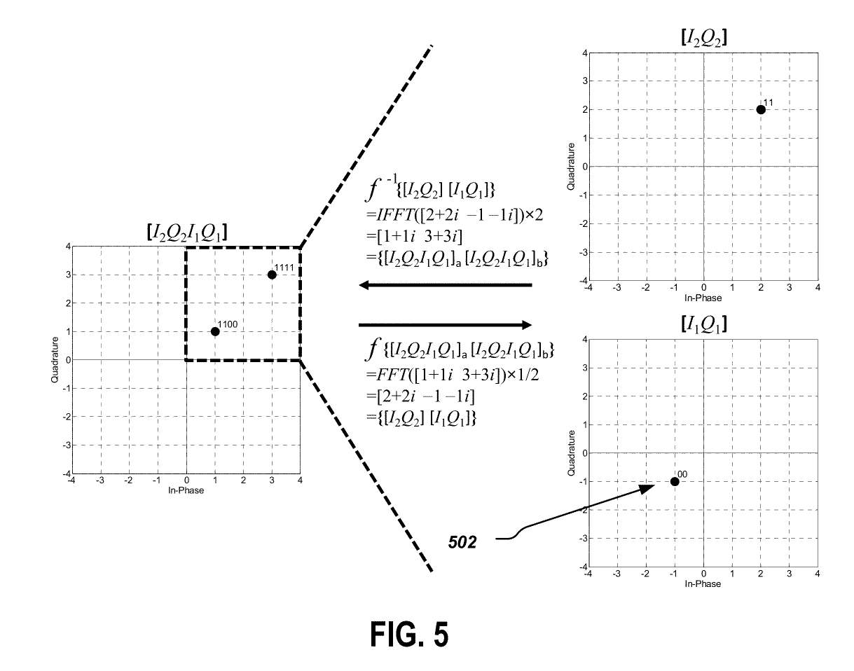

FIG. 5 shows a similar example in which [I₁Q₁] is changed to 00 (reference numeral 502). Intuitively, both examples in FIG. 4 and FIG. 5 show the same 16-QAM symbols after the mapping; however, by comparing the mapped 16-QAM symbols in both examples in serial, it is seen that they have different orders, which are [3+3i 1+1i] and [1+1i 3+3i] in FIGS. 4 and 5, respectively. That means such 2-on-2 mapping and de-mapping is unique and has no redundancy. When de-mapping [1+1i 3+3i] is performed by taking FFT, the obtained [I₁Q₁] will always be 00, not 11.

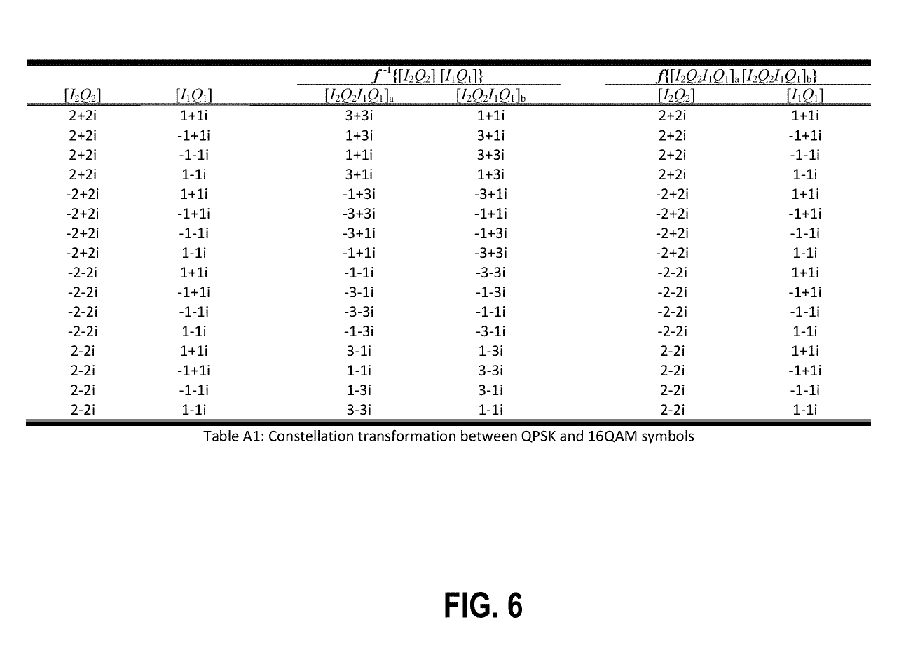

In FIG. 6, Table A1 summarizes all the constellation transformation points in an example 16-QAM mapping and de-mapping scheme in accordance with some embodiments.

In some embodiments, the 16-QAM the amplitude ratio may be greater than 1, but can be smaller than 2 in order to pre-compensate the distortion.

The 16-QAM example above is for illustration. The same concept can be used to generate a higher order format signal such as 64-QAM by using a cascade of orthogonal 16QAM and QPSK symbols, which can be implemented by FFT and IFFT as well.

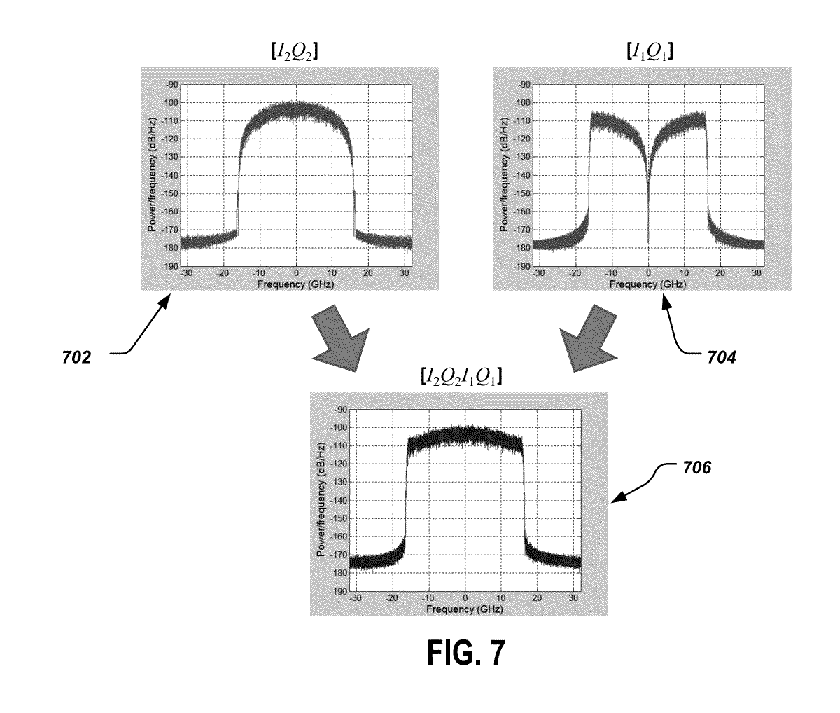

FIG. 7 depicts exemplary spectra of modulated signals. This example shows the spectrum 706 of a 16QAM signal [I2Q2I1Q1] consisting of two orthogonal QPSK signals ([I2Q2] 702 and [I1Q1] 704) at 16 Gbaud (Giga symbols per second). The spectra 702 and 704 in red show the individual QPSK signals, [I2Q2] and [I1Q1], respectively.

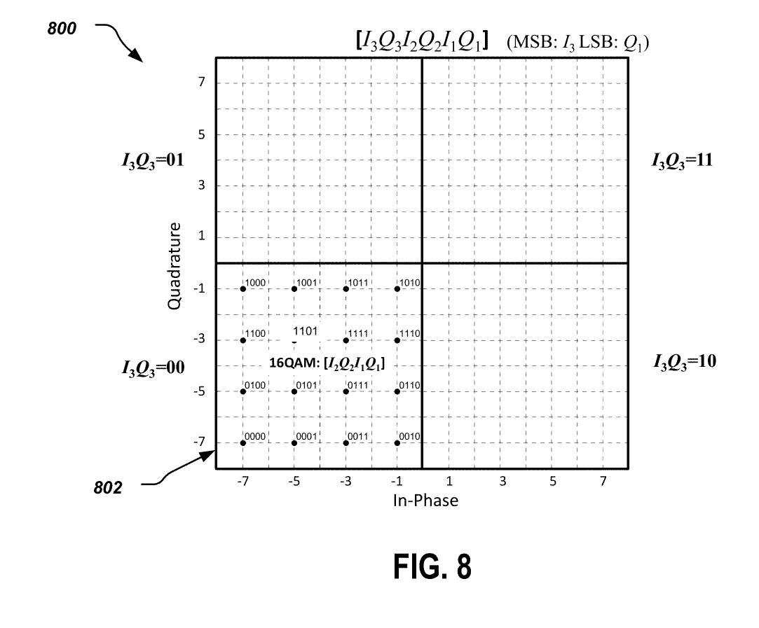

FIG. 8 shows a quadrant 802 of an exemplary 64 QAM constellation map 800. This example shows that the disclosed scheme is scalable to 64QAM by using orthogonal 16QAM and QPSK, in which 16QAM can be a regular Gray-coded signal (in this example) or a 16QAM (with orthogonal QPSK signals, as previously described with respect to FIG. 2).

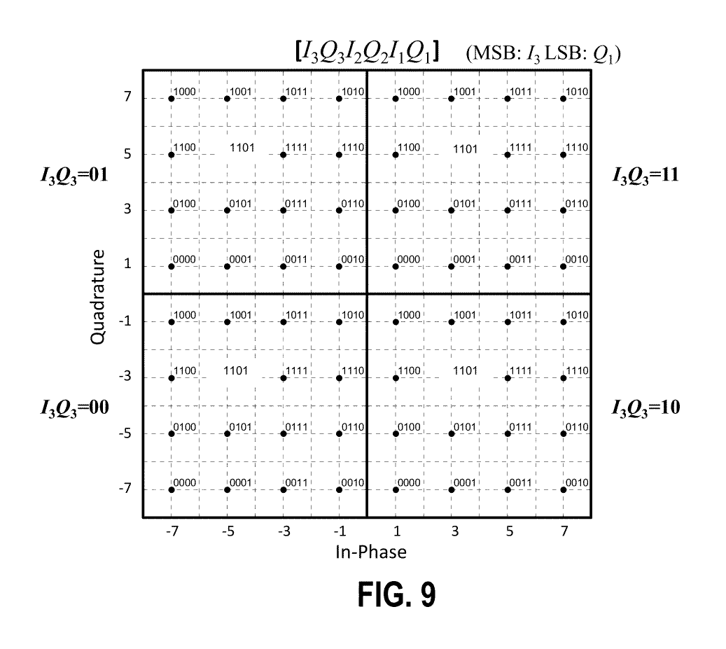

FIG. 9 shows an exemplary 64-QAM constellation map generated using a multi-stage approach as described in the present document. It will be appreciated that the 64-QAM constellation depicted in FIG. 9 can be de-mapped in two steps—initial two bits indicating a quadrant to which a symbol belongs to, and the remaining bits corresponding to the relative position of the symbol within each quadrant.

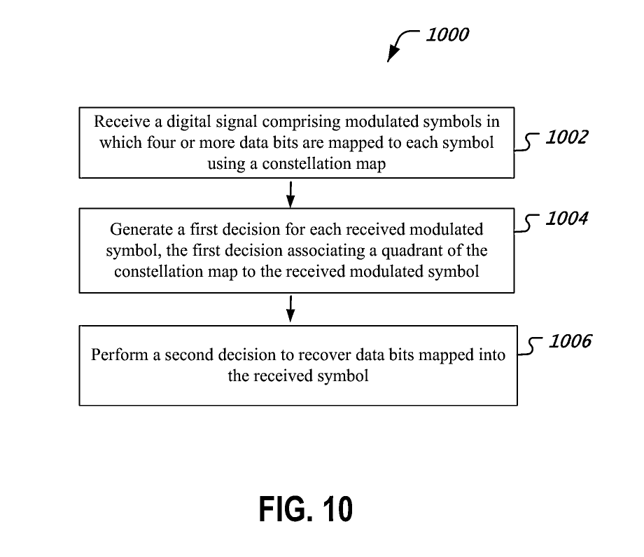

FIG. 10 is a flowchart representation of an exemplary method 1000 of digital communication. The method 1000 may be implemented in an optical receiver, e.g., receiver 106.

At 1002, the method 1000 receives a digital signal comprising modulated symbols in which four or more data bits are mapped to each symbol using a constellation map. The constellation map may be generated along the techniques disclosed in the present document. In some embodiments, the constellation map may be different from a Gray mapped constellation map.

At 1004, the method 1000 generates a first decision for each received modulated symbol, the first decision associating a quadrant of the constellation map to the received modulated symbol. The first decision, e.g., may simply be to decide which ones of four quadrants of a constellation map the symbol being received may fall into.

At 1006, the method 1000 performs, based on the quadrant of the constellation map associated with the received modulated symbol, a second decision to recover data bits mapped into the received symbol. In some embodiments, the second decision may be performed by first processing the received signal based on the first decision. For example, referring back to the constellation maps of FIGS. 2 and 9, in some embodiments, the first stage may provide a decision about which quadrant 204, 206, 208, 210 is the received symbol in. Next, the second stage may process the signal, e.g., scale the signal or re-center the signal and then perform a second stage de-mapping (e.g., a QPSK de-mapping for the QPSK-like constellation within one of quadrants 202, 204, 206, 208, or a second stage 16-QAM demapping for quadrants for constellation map in FIG. 9).

As disclosed herein, once the first quadrant is decided in the first stage, then the subsequent decisions may be taken on where within the decided quadrant the symbol maps to. In other words, after the initial decision about the quadrant, the next decision may not change the initial quadrant decision, but may simply refine the location of the symbol to a constellation point within the quadrant selection of the earlier stage.

In some embodiments, the method 1000 may include performing estimation of a channel using a QPSK technique. For example, in the example discussed in FIG. 4 and FIG. 5, a 16-QAM signal was processed as two stages of QPSK decision—a first stage in which a quadrant was decided and a second stage in which a quadrant within the first decided quadrant was decided. In other words, each decision stage made a QPSK-like quadrant decision on the received symbol. In some embodiments, the channel estimation may be performed using a blind algorithm, e.g., without the use of a pilot signal or a training sequence.

In some embodiments, the received signal undergoes processing based on the first decision and before making a second decision about the constellation mapping of the received symbol. For example, as disclosed in this document, the signal is scaled and/or re-centered to facilitate constellation mapping decision process by the next stage.

In some embodiments, e.g., 64-QAM, a received symbol may be mapped to a higher order QAM constellation using a first QPSK (quadrant) decision and a second stage of QAM decision process (e.g., 16-QAM). Advantageously, because the first stage is a QPSK stage, computationally lower complexity channel equalization techniques such as blind equalization can be used in spite of the underlying signals being higher order QAM modulated signals.

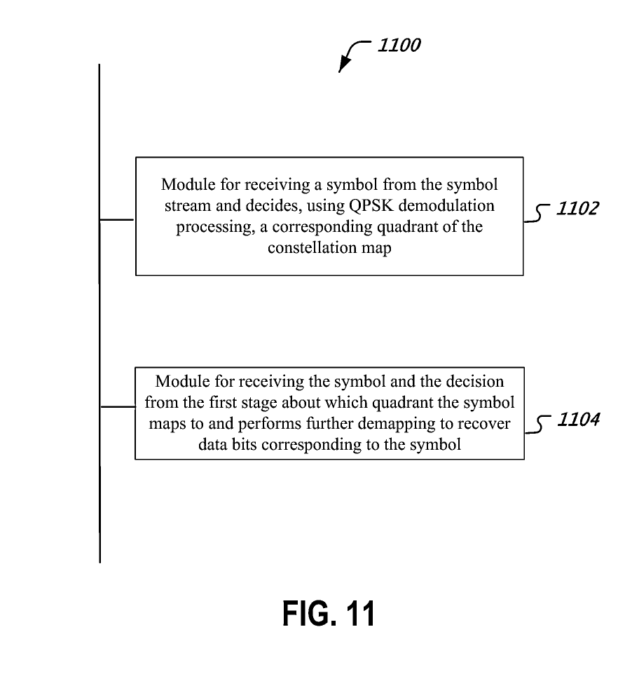

FIG. 11 is a block diagram representation of an exemplary digital communication apparatus 1100 for processing a symbol stream to generate data encoded by the symbol stream. Each symbol represents a fixed number of data bits of a constellation map, and the fixed number is an integer greater than three. The constellation map represents a one-to-one correspondence all possible combinations of the fixed number of data bits and a corresponding symbol. The apparatus includes a first stage (1102) that receives a symbol from the symbol stream and decides, using quadrature phase shift keying (QPSK) demodulation processing, a corresponding quadrant of the constellation map the symbol maps to, and a second stage (1104) that receives the symbol and the decision from the first stage about which quadrant the symbol maps to and performs further de-mapping to recover data bits corresponding to the symbol. The apparatus 1200 and the first stage 1102 and second stage 1104 may further be configured to perform some of the operations described in the present document.

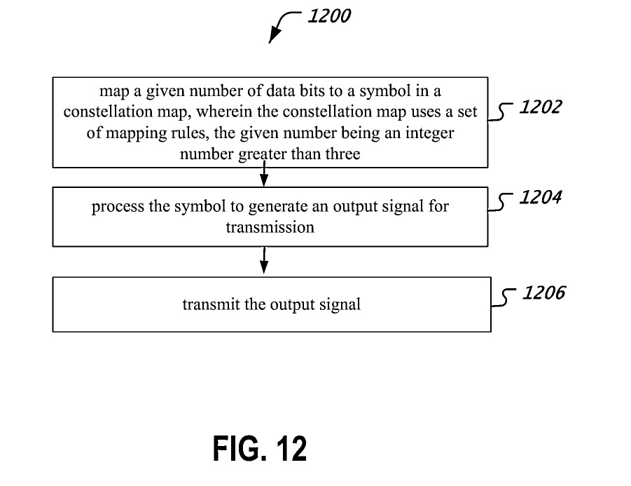

FIG. 12 is a flowchart representation of an example method 1200 of transmitting digital signals. In various embodiments, the method 1200 may be implemented in the transmitter portion of apparatuses 102 and 106.

At 1202, the process 1200 maps a given number of data bits to a symbol in a constellation map, wherein the constellation map uses a set of mapping rules, the given number being an integer number greater than three.

At 1204, the method 1200 processes the symbol to generate an output signal for transmission.

At 1206, the method 1200 transmits the output signal. The output signal may be frequency-upconverted to a desired radio frequency (RF) channel and transmitted over the transmission medium, e.g., optical or air medium.

In some embodiments, the set of mapping rules includes a first rule that uniquely maps the given number of data bits to a quadrant of the constellation map based on an initial two bits and a second rule that maps the given number of data bits to a symbol within the quadrant, arranged using a first Gray encoding, using remaining bits. One example mapping is depicted in FIG. 9 in which the initial two bits of a data symbol are used to map to the quadrant to which the data symbol maps in a Gray coded format (e.g., adjacent quadrant have a one bit change and diagonally opposite quadrants have a two-bit change). The adjective “initial” is only used for ease of explanation. Since all bits in a data set that gets mapped to a symbol are transmitted at the same time, “initial” does not necessarily mean that these two bits are transmitted first in time. Similarly, based on the endian-ness of data received at the input of the first stage, “initial” bits may represent bits received first in time or last in time at the input of the first stage.

In some embodiments, a 5-bit constellation map may comprise a Gray encoded quadrant mapping using initial two bits, followed by 8 QAM mapping within each quadrant using the remaining 3 bits.

In some embodiments, a 6th order constellation map (e.g., mapping 6 data bits to a symbol) may comprise a 2-bit quadrant mapping using the initial two bits, followed by a 2-bit quadrant mapping within each first stage quadrant using next two bits, followed by a 2-bit QPSK mapping within each second stage quadrant.

It will be appreciated that many variations may be possible at the transmitter side for selecting symbol mapping rules. In general, an Nth order constellation map may be achieved by splitting into multiple M stages, each stage having an order Nk, where k is an integer from 1 to M, such that N1+N2+ . . . NM adds to N. The Nk^{th} order constellation mapping in the k^{th} stage may use Gray encoded or non-Gray encoded constellation map to further define a symbol region to which given N input bits map to. At a receiver-side, recovering data bits from received symbols may similarly be performed using an M stage de-mapping process.

In some embodiments, an optical communication network includes an optical transmitter configured to map a given number of data bits to a symbol in a constellation map, wherein the constellation map uses a set of mapping rules, the given number being an integer number greater than three, process the symbol to generate an output signal for transmission, and transmit the output signal to an optical transmission medium. The network further may include an optical receiver configured to receive the output signal over the optical transmission medium, generate a first decision for each received modulated symbol, the first decision associating a quadrant of the constellation map to the received modulated symbol and perform, based on the quadrant of the constellation map associated with the received modulated symbol, a second decision to recover data bits mapped into the received symbol.

It will be appreciated that the disclosed digital communication method techniques can be used to improve performance of a digital communication transmitter and/or receiver. It will also be appreciated that, in some embodiments, a received signal that includes N-bit per symbol mapping, where N is an integer greater than 3, may be performed in multiple de-mapping stages, where a first stage may be a QPSK-like stage to decide which quadrant of the Nth order constellation map a received signal belongs to. In one advantageous aspect, processing the received high order modulated signal at the receiver as a QPSK signal in the first stage lends itself to the use of robust channel estimation/ equalization techniques (e.g., blind constant modulation algorithm, CMA).

It will further be appreciated that the disclosed techniques may be used to increase the distance between an optical transmitter and an optical receiver, while achieving a target data throughput rate at a given output power.

The disclosed and other embodiments, modules and the functional operations described in this document (e.g., the first stage, the second stage, etc.) can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is what is described and illustrated, including:

1. A method of digital communication, comprising:
receiving a digital signal comprising modulated symbols in which four or more data bits are mapped to each symbol using a constellation map;
generating a first decision for each received modulated symbol, the first decision associating a quadrant of the constellation map to the received modulated symbol; and
performing, based on the quadrant of the constellation map associated with the received modulated symbol, a second decision to recover data bits mapped into the received symbol.

2. The method of claim 1, further comprising:
performing channel estimation using a quadrature phase shift keying (QPSK) technique.

3. The method of claim 1, wherein the performing the second decision comprises:
processing, using the first decision, the received signal, prior to performing the second decision.

4. The method of claim 3, wherein the processing comprises a signal scaling operation.

5. The method of claim 3 wherein the processing comprises a signal re-centering operation.

6. The method of claim 1, wherein the performing the second decision comprises:
determining data bits using quadrature amplitude modulation (QAM) decoding technique.

7. An apparatus for processing a symbol stream to generate data encoded by the symbol stream, wherein each symbol represents a fixed number of data bits of a constellation map, wherein the fixed number is an integer greater than three, and wherein the constellation map represents a one-to-one correspondence all possible combinations of the fixed number of data bits and a corresponding symbol, comprising:
a first stage that receives a symbol from the symbol stream and decides, using quadrature phase shift keying (QPSK) demodulation processing, a corresponding quadrant of the constellation map the symbol maps to; and
a second stage that receives the symbol and the decision from the first stage about which quadrant the symbol maps to and performs further demapping to recover data bits corresponding to the symbol.

8. The apparatus of claim 7, further comprising:
a channel estimation module that estimates a channel over which the symbol stream received using a QPSK technique.

9. The apparatus of claim 7, wherein the second stage comprises a signal scaling module that scales a signal output of the first stage.

10. The apparatus of claim 7, wherein the fixed number is equal to 6 and the second stage comprises a 16 quadrature amplitude modulation (QAM) processing module.

11. A digital communication apparatus, comprising:
means for receiving a digital signal comprising modulated symbols in which four or more data bits are mapped to each symbol using a constellation map;
means for generating a first decision for each received modulated symbol, the first decision associating a quadrant of the constellation map to the received modulated symbol; and
means for performing, based on the quadrant of the constellation map associated with the received modulated symbol, a second decision to recover data bits mapped into the received symbol.

12. The apparatus of claim 11, further comprising:
means for performing channel estimation using a quadrature phase shift keying (QPSK) technique.

13. The apparatus of claim 11, wherein the means performing the second decision comprises:
means for processing, using the first decision, the received signal, prior to performing the second decision.

14. The apparatus of claim 13, wherein the means for processing comprises a means for signal scaling.

15. The apparatus of claim 13 wherein the means for processing comprises a means for signal re-centering.

16. The apparatus of claim 11, wherein the means for performing the second decision comprises:
means for determining data bits using quadrature amplitude modulation (QAM) decoding technique.

17. A method of digital communications, comprising:
mapping a given number of data bits to a symbol in a constellation map, wherein the constellation map uses a set of mapping rules, the given number being an integer number greater than three;
processing the symbol to generate an output signal for transmission; and
transmitting the output signal;
wherein the set of mapping rules includes a first rule that uniquely maps the given number of data bits to a quadrant of the constellation map based on an initial two bits and a second rule that maps the given number of data bits to a symbol within the quadrant, arranged using a first Gray encoding, using remaining bits.

18. The method of claim 17, wherein the set of mapping rules includes a third rule that provides a mapping between the initial two bits and the quadrants using a second Gray encoding.

19. A digital communication apparatus, comprising:
a mapper module that maps a given number of data bits to a symbol in a constellation map, wherein the constellation map uses a set of mapping rules, the given number being an integer number greater than three;
a transmit chain that processes the symbol to generate an output signal for transmission; and
a signal transmitter that transmits the output signal to a transmission medium;
wherein the set of mapping rules includes a first rule that uniquely maps the given number of data bits to a quadrant of the constellation map based on an initial two bits and a second rule that maps the given number of data bits to a symbol within the quadrant, arranged using a first Gray encoding, using remaining bits.

20. An optical communication system, comprising:
an optical transmitter configured to:
map a given number of data bits to a symbol in a constellation map, wherein the constellation map uses a set of mapping rules, the given number being an integer number greater than three;
process the symbol to generate an output signal for transmission; and
transmit the output signal to an optical transmission medium;
wherein the set of mapping rules includes a first rule that uniquely maps the given number of data bits to a quadrant of the constellation map based on an initial two bits and a second rule that maps the given number of data bits to a symbol within the quadrant, arranged using a first Gray encoding, using remaining bits;
the optical transmission medium; and
an optical receiver configured to:
receive the output signal over the optical transmission medium;
generate a first decision for each received modulated symbol, the first decision associating a quadrant of the constellation map to the received modulated symbol; and
perform, based on the quadrant of the constellation map associated with the received modulated symbol, a second decision to recover data bits mapped into the received symbol.
